(19) United States
(12) Patent Application Publication
(10) Pub. No.: US 2023/0361409 A1
(43) Pub. Date: Nov. 9, 2023

(54) A BATTERY AND A MODULAR BATTERY SYSTEM FOR A POWER TOOL

(71) Applicant: HUSQVARNA AB, Huskvarna (SE)

(72) Inventors: Glenn Torsténi, Jonsered (SE); Philip Dolk, Jönköping (SE)

(21) Appl. No.: 18/029,455

(22) PCT Filed: Sep. 22, 2021
(86) PCT No.: PCT/SE2021/050915

§ 371 Date: Mar. 30, 2023

(30) Foreign Application Priority Data
Oct. 1, 2020 (WO) PCT/EP2020/077590
Dec. 15, 2020 (SE) 2051462-6

(51) Int. Cl. H01M 10/6235; H01M 50/247; H01M 50/213; H01M 10/6561; H01M 50/262; H01M 10/613; H01M 50/258

(52) U.S. Cl. CPC H01M 50/247; H01M 10/613; H01M 10/6235; H01M 10/6561; H01M 50/213; H01M 50/258; H01M 50/262; B25F 5/02

(57) ABSTRACT

A battery (300) for a power tool, the battery comprising: a central housing (310) with at least one side (301) terminated by a first gable portion (320), and by a second gable portion (330) opposite to the first gable portion, wherein the gable portions (320, 330) face in an insertion direction (D) of the battery, one or more guiding members (340a, 340b) arranged on the central housing (310) to guide the battery along the insertion direction (D1) into mating position with attachment means of the power tool (100), one or more electrical connectors (810) arranged in respective elongated slots (350) formed in the central housing (310), wherein the slots extend in the insertion direction (D2), where the one or more guiding members (340a, 340b) and the one or more slots (350) extend in a plane (P) tangential to the side (301) of the central housing (310), wherein the battery further comprises a handle (360) arranged on the second gable portion (330), where the handle is offset (O) from a center of the second gable portion (330) towards the plane (P).

### TECHNICAL FIELD

The present disclosure relates to batteries for electrically powered and hybrid electric power tools. The batteries are suitable for use with hand-held construction equipment such as cut-off tools, core drills, and saws for cutting concrete and stone, as well as chainsaws and also for lawn and grounds care products, i.e., lawn movers and the like.

### BACKGROUND

Advancements in battery technology has enabled battery powered electrical power tools which perform at the same level as corresponding power tools powered via cable from mains or by combustion engine. For instance, battery powered cut-off tools, chain saws, and various types of outdoor power tools and products for lawn and grounds care can today be driven by electric motors powered by rechargeable batteries where previously a cable to mains or a combustion engine was required. Hybrid power tools have also been proposed which make use of a combination of rechargeable battery and combustion energy to perform the task at hand in an efficient manner.

However, applications like the above-mentioned still require a significant amount of stored energy and to be able to deliver sufficient power. Thus, the batteries may be relatively large and heavy. Handling of such heavy batteries may be challenging. For instance, inserting and removing a large and heavy battery into a battery compartment of a power tool or a charging unit may be difficult since the battery may get stuck in the battery compartment. Furthermore, energy requirements may vary between different applications and between different tools. A versatile battery system is therefore desired which supports different applications.

There is a need for improved batteries for electrically powered and hybrid power tools.

### SUMMARY

It is an object of the present disclosure to provide improved batteries for power tools which resolve or at least mitigate some of the above-mentioned issues.

This object is obtained by a battery for a power tool. The battery comprises a central housing with at least one side terminated by a first gable portion and by a second gable portion opposite to the first gable portion, wherein the gable portions face in an insertion direction of the battery. The battery also comprises one or more guiding members arranged on the central housing to guide the battery along the insertion direction into mating position with attachment means of the power tool. One or more electrical connectors are arranged in respective elongated slots formed in the central housing, wherein the slots extend in the insertion direction. The one or more guiding members and the one or more slots extend in a plane tangential to the side of the central housing. The battery further comprises a handle arranged on the second gable portion, where the handle is offset from a center of the second gable portion towards the plane.

Since the handle is offset towards the plane, forces exerted on the handle in the insertion direction align with the elongation directions of the one or more guiding members as well as with the one or more slots. This alignment of forces reduces a pivoting motion by the battery as it is inserted into the mating position and also as it is removed from the mating position. Thus, connecting and disconnecting the battery to a power tool is simplified.

The batteries disclosed herein can also be aggregated into a larger stationary power source and used to power larger tools or a smaller tool for a longer period of time.

According to aspects, the battery comprises a first guiding member and a second guiding member extending in the plane, where the one or more elongated slots are arranged in-between the first and second guiding members on the side of the central housing. This arrangement provides for a stable mechanical connection between battery and power tool, and also provides for a convenient insertion and removal operation of the battery with respect to a battery compartment of the power tool, or with respect to other battery holding arrangements on the power tool.

According to aspects, the first gable portion, and/or the second gable portion is formed with a beveled edge. This bevel or chamfer simplifies insertion of the battery into a battery compartment since it acts as an initial guide to align the gable portion face with the battery compartment aperture.

According to aspects, the electrical connectors are surface mounted onto a carrier structure arranged in the central housing, where the carrier structure further comprises a control unit for controlling an operation of the battery. This joint carrier structure simplifies assembly of the battery and provides for a more cost-efficient design overall. The carrier structure may, e.g., be a printed circuit board (PCB) supporting both the electrical connectors, power circuitry, as well as the control unit.

According to aspects, the first gable portion and/or the second gable portion are attached to the central housing by one or more releasable fastening members. These releasable fastening members, e.g., threaded members such as screws or bolts, simplify assembly and disassembly of the battery, and therefore provide, e.g., more convenient recycling of the battery.

According to aspects, the slots and the guiding members are formed in a cuboid shaped protrusion extending from the central housing along a normal vector to the plane, where a surface of the cuboid shaped protrusion is parallel to the plane. A leading edge of this cuboid shaped protrusion may form an abutment arranged to support the battery relative to the power tool when in the mating position. This arrangement provides improved mechanical robustness of the overall battery system. The control unit may advantageously be mounted inside the cuboid shaped protrusion, where it is protected while still close to the electrical connectors.

According to aspects, at least one of the elongated slots defines a passage into an internal volume of the central housing for passing a flow of cooling air from the internal volume and out into an ambient environment. This flow of cooling air keeps the electrical connectors free from dust and slurry, or at least reduces the amount of particulate matter entering into the local area comprising the electrical connectors, which is an advantage.

According to aspects, the guiding members are arranged to mate with corresponding dove-tail grooves formed in the power tool. This arrangement provides an increased mechanical strength suitable for heavy duty batteries and power tools.

According to aspects, the battery comprises a groove extending in the insertion direction, arranged on a side of the central housing opposite to the elongated slots and the guiding members to mate with a supporting heel arranged on a wall of a battery compartment formed in the power tool. This optional support structure further enhances the mechanical robustness of the mechanical connection between battery and power tool.

According to aspects, the battery comprises at least one recess configured to receive a respective locking member of a battery lock mechanism, wherein the recess comprises a surface arranged with an arcuate form to match that of a leading edge portion of the locking member. This particular form of mechanism simplifies releasing the battery from the mating position, which is an advantage.

The object is also obtained by a modular battery system comprising a plurality of battery types, where each battery type is configured for insertion in an insertion direction into mating position with attachment means of a power tool. Each battery type comprises a central housing defining a central volume, one or more guiding members arranged on the central housing to guide the battery into the mating position along the insertion direction, and one or more electrical connectors arranged in respective elongated slots formed in the central housing, where the slots extend in the insertion direction. Each battery type further comprises a first gable portion and a second gable portion arranged opposite to the first gable portion, wherein the gable portions face in the insertion direction, and where each gable portion defines a respective first and second gable volume. The central housing is the same for each battery type in the plurality of battery types, while the first and/or second gable volume differs between a first battery type and a second battery type in the plurality of battery types. By having the same central housing on all types of batteries in the modular battery system and different gable portions, the energy capacity of the battery can be adapted to the power tool and task at hand, without changing any of the interfaces towards the power tool or towards a battery charger, since both mechanical attachment arrangement and the electrical connectors are arranged on the central housing which is the same for all types.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where

FIG. 1 shows an example power tool;

FIG. 2 illustrates an example battery compartment for a battery;

FIGS. 3A-C illustrate an example battery of a first type;

FIG. 4 illustrates an example battery of a second type;

FIG. 5 schematically illustrates aligned components on a battery;

FIGS. 6-7 illustrate battery types comprised in a modular battery system;

FIG. 8 illustrates electrical connectors on a battery; and

FIG. 9 shows an example battery pack for a battery;

### DETAILED DESCRIPTION

The invention will now be described more fully hereinafter with reference to the accompanying drawings, in which certain aspects of the invention are shown. This invention may, however, be embodied in many different forms and should not be construed as limited to the embodiments and aspects set forth herein; rather, these embodiments are provided by way of example so that this disclosure will be thorough and complete, and will fully convey the scope of the invention to those skilled in the art. Like numbers refer to like elements throughout the description.

It is to be understood that the present invention is not limited to the embodiments described herein and illustrated in the drawings; rather, the skilled person will recognize that many changes and modifications may be made within the scope of the appended claims.

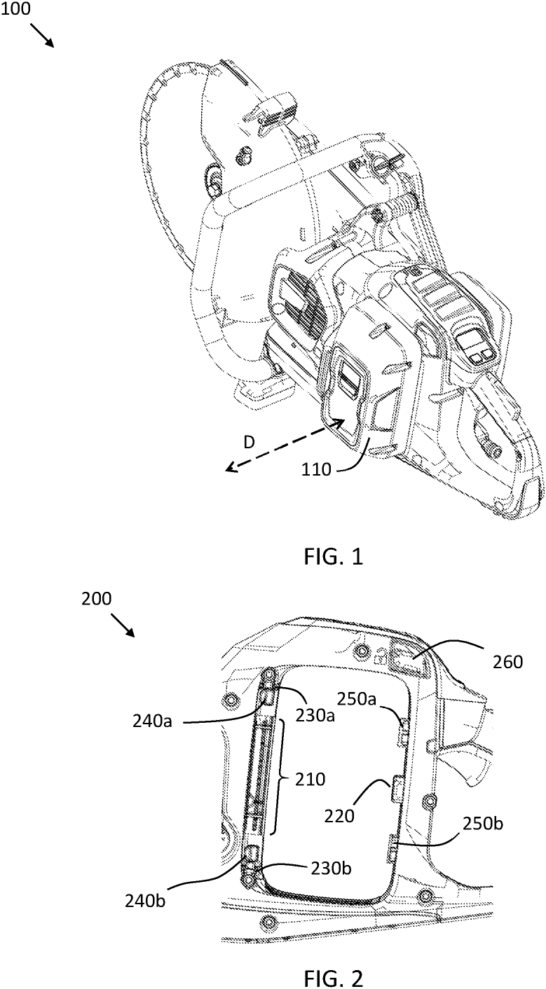

FIG. 1 shows a hand-held power tool 100. The power tool 100 in FIG. 1 is an electrically powered cut-off tool, but the techniques and devices disclosed herein can also be applied to other types of handheld electrically powered tools, such as chainsaws, blowers, clearing saws and hedge trimmers. The herein disclosed techniques and devices can also be used with electrically powered tools such as core drills, and gardening equipment such as lawn movers, pressure washers and the like.

The power tool 100 comprises a battery 110 for powering the tool. This particular battery is arranged inserted into a through-hole battery compartment 200, shown in more detail in FIG. 2. The battery is inserted into the battery compartment in an insertion direction D into a mating position where electrical connectors on the battery are in electrical connection with corresponding electrical connectors 210 on the power tool. The batteries discussed herein are particularly suitable for insertion into a through-hole battery compartment like the battery compartment 200 illustrated in FIG. 2. However, it is appreciated that the batteries disclosed herein may also be attached externally to a power tool, by means of externally mounted attachment means on the power tool.

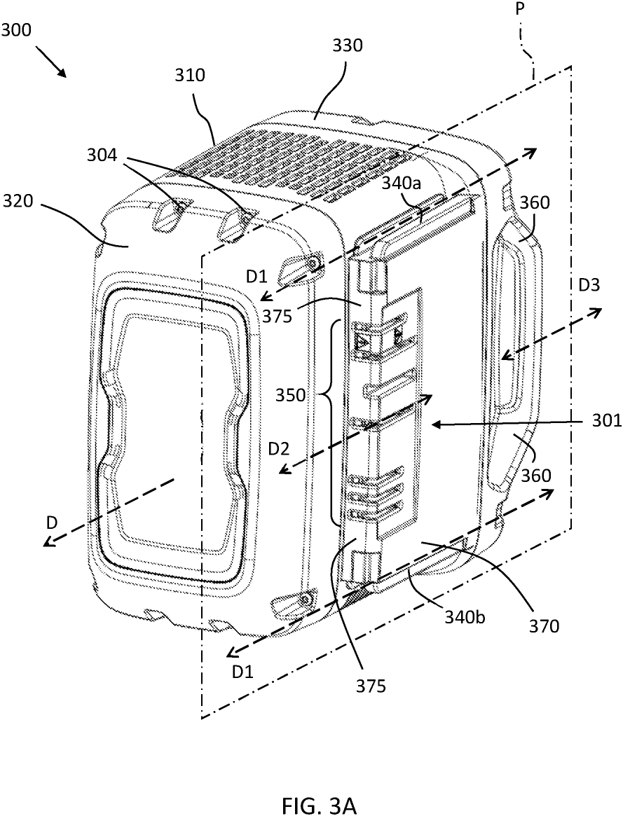

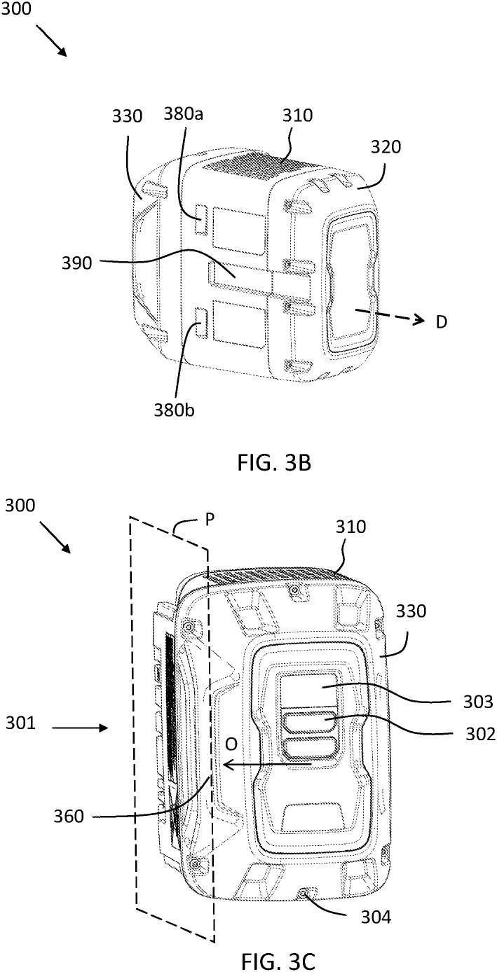

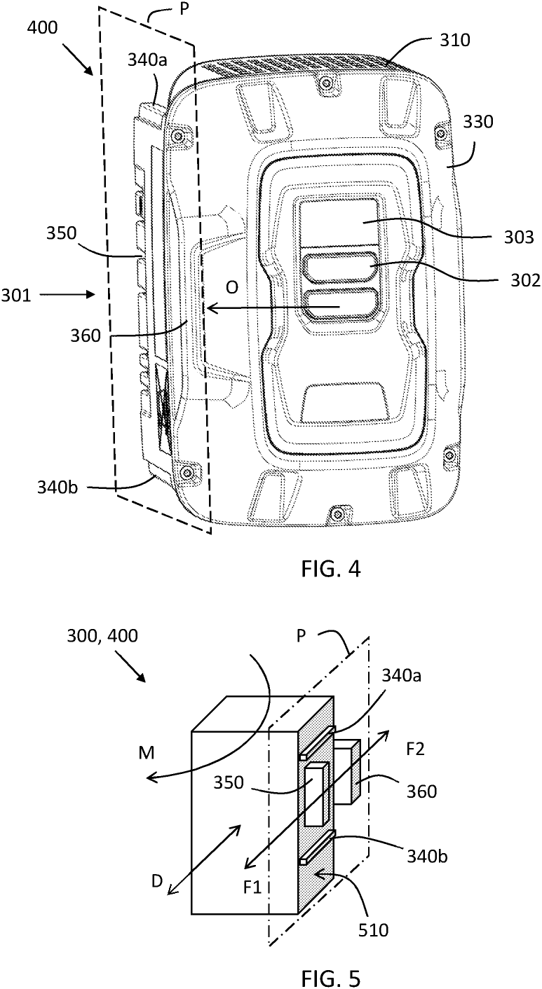

FIGS. 3A-3C show views of a battery 300 of a first type. This battery 300 has a larger energy storage capacity compared to the battery 400 illustrated in FIG. 4 which is of a second type. The battery of the first type may weigh about 5100 g while the battery of the second type may weigh about 3000 g. Both batteries are of rugged design and may be referred to as heavy duty batteries suitable for outdoor use in harsh environments associated with dust, slurry, and other particulate matter. It is therefore of importance that the mechanical connection between battery and power tool is robust and of high mechanical strength.

With reference to FIGS. 3A-C and 4, there is illustrated a battery 300, 400 for a power tool 100. The battery comprises a central housing 310 terminated by a first gable portion 320 and a second gable portion 330 opposite to the first gable portion. The gable portions 320, 330 extend transversally to a side 301 of the central housing 310 and face in the insertion direction D. This example central housing has a rounded rectangular cross-section shape with four sides. It therefore has rounded rectangle shaped apertures which are covered by the gable portions. It is noted that other battery shapes are also possible, i.e., where the central housing is of a more tubular shape or has a triangular or more general polygonal cross section shape. This particular arrangement shown in FIGS. 3A-C and 4 has the advantage of being easy to assemble. A battery pack 900, which will be discussed in more detail below in connection to FIG. 9, is first inserted into the central housing, and the battery is then closed by means of the first and second gable portions which are formed separate from the central housing. The contact area between gable portion and central housing may comprise a resilient seal, but this is entirely optional. According to some aspects, the first gable portion 320 and/or the second gable portion 330 are attached to the central housing 310 by one or more releasable fastening members 304, e.g., as illustrated in FIG. 3A where threaded members (such as screws or bolts) are used to attach the gable portions to the central housing.

One or more guiding members 340a, 340b are arranged on the central housing 310 to guide the battery along an insertion direction D1 into mating position with attachment means of the power tool 100. The attachment means on the power tool may, e.g., be arranged in a battery compartment 200 as shown in FIG. 2, or on the outside of the power tool. According to an example, the guiding members 340a, 340b are arranged to mate with corresponding dove-tail grooves 230a, 230b formed in the power tool 100, as exemplified in FIG. 2.

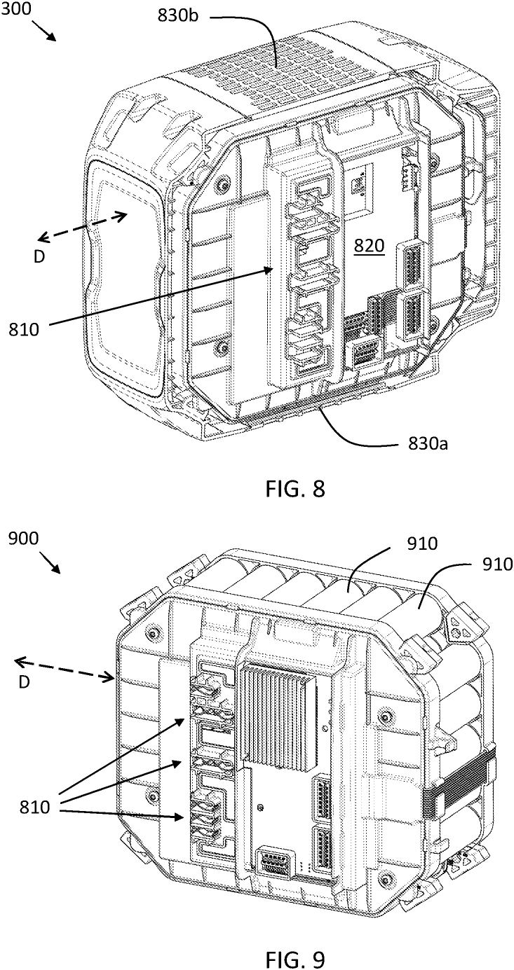

With reference also to FIG. 8, one or more electrical connectors 810 are arranged in respective elongated slots 350 formed in the central housing 310. Notably, the slots extend in the insertion direction D2, i.e., in the same direction are the guiding members 340a, 340b. As the battery is guided into the mating position with the power tool 100, the electrical connectors on the power tool come into electrical contact with the electrical connectors on the battery, which connection powers the power tool 100.

As shown in FIGS. 3A, 3C and 4, the one or more guiding members 340a, 340b and the one or more slots 350 extend parallel to a plane P tangential to the side 301 of the central housing 310. Here, tangential means that the plane extends in the same general directions as the side 301 of the central housing 310, and tangential to a surface of the side 301. It is appreciated that the location and orientation of the plane P depends on the shape of the central housing. For a rectangular (or rounded rectangular) cross-section central housing like that illustrated in FIGS. 3A, 3C and 4, the plane more or less coincides with the side 301.

The battery further comprises a handle 360 arranged on the second gable portion 330. This handle 360 is offset O from a center of the second gable portion 330 towards the plane P. In other words, the handle is displaced towards the side of the battery comprising the one or more guiding members 340a, 340b and the one or more slots 350. In a preferred embodiment the handle is offset all the way to the corner formed between the gable portion and the central housing. In this case the one or more guiding members 340a, 340b, the one or more slots 350 and the handle are all intersected by the plane P.

The handle 360 can, for example, be formed as a recess in the second gable portion 330 as shown in the figures, or it can be a protruding separate member attached to the second gable portion 330 at a position which is biased towards the plane P. Various handle designs for batteries are known and will therefore not be discussed in more detail herein.

The handle 360, the one or more guiding members 340a, 340b and the one or more slots 350 all extend in the insertion direction. Furthermore, the handle 360, the one or more guiding members 340a, 340b and the one or more slots 350 are at least biased towards the plane, and in a preferred embodiment extend in the plane P. This means that a force exerted on the handle 360, i.e., a pushing force to push the battery into mating position with the power tool 100, or a pulling force for removing the battery from the power tool 100, will be aligned with the extension directions of both the one or more guiding members 340a, 340b and the one or more slots 350. This further means that pivoting by the battery with respect to the attachment means of the power tool, e.g., the guides in the battery compartment 200, due to operating the handle is minimized. Consequently, inserting of the battery into mating position with the power tool, and removal of the battery from the power tool, is made easier due to the offset handle because of the reduction in pivoting motion by the battery.

FIG. 5 schematically illustrates this concept. A force F1 acting to push the battery 300, 400 into mating position is aligned with the extension direction of the one or more guiding members 340a, 340b and the one or more slots 350. Thus, there is no pivoting motion M by the battery as it enters into mating position. The same holds for when an opposite force F2 is exerted on the handle to remove the battery from the mating position. Thus, insertion and removal of the battery into and out from the mating position is simplified by the relative arrangement of the electrical connectors, the guiding members, and the handle. In a preferred embodiment, the handle 360 intersects the plane P in alignment with the elongated slots 350 and with the guiding members 340a, 340b.

Various mechanical arrangements may be applied for guiding the battery into the locking position, which locking position may be inside a through-hole battery compartment 200 as exemplified in FIG. 2, or on the outside of the power tool. According to one example, the battery comprises a first guiding member 340a and a second guiding member 340b extending parallel to the plane P, where the one or more elongated slots 350 are arranged in-between the first and second guiding members 340a, 340b on the side 301 of the central housing. In this respect, when the battery is positioned as in FIG. 3A, the first guiding member may be referred to as an upper guiding member and the second guiding member may be referred to as a lower guiding member. The guiding members 340a, 340b may optionally form a dove-tail arrangement together with the corresponding members 230a, 230b on the power tool.

To simplify attaching the battery to a power tool, e.g., by inserting it into a battery compartment 200 such as that exemplified in FIG. 2, the first gable portion 320, and/or the second gable portion 330 can optionally be formed with a beveled edge. This bevel or chamfer simplifies insertion since the battery is initially guided by the bevel to enter the aperture of the battery compartment.

With reference to, e.g., FIGS. 3C and 4, the first and/or second gable portion 320, 330 optionally comprises a manual control input interface 302 arranged communicatively coupled to the control unit and/or an information output interface 303 arranged communicatively coupled to the control unit. These interfaces provide a means for communicating information to a user, such as a battery charge status and the like. Means for inputting control commands and the like are provided by the input interface 302. Such control commands may, e.g., be associated with querying the battery for a certain status signal or the like.

The slots 350 and the guiding members 340a, 340b are preferably formed in a cuboid shaped protrusion extending from the central housing along a normal vector to the plane P, as illustrated in, e.g., 3A, where a surface of the cuboid shaped protrusion 370 is parallel to the plane P. A leading edge 375 of the cuboid shaped protrusion 370 optionally forms an abutment arranged to support the battery relative to the power tool 100 when in the mating position. For instance, the leading edge can be configured such as to abut against one or more resilient members 240a, 240b, for instance spring-loaded taps or protrusions formed in a resilient material such as rubber or the like. These resilient members provide a counter-force to the battery when the battery is in the mating position. With reference to FIG. 5, this counter-force is aligned with force F2 and therefore follows the general concept of force alignment discussed herein to simplify insertion and removal of the battery in and from the power tool 100.

With reference to FIG. 2 and FIG. 3B, the batteries discussed herein optionally comprise a groove 390 extending in the insertion direction D, arranged on a side of the central housing 310 opposite to the side with the elongated slots 350 and the guiding members 340a, 340b to mate with a supporting heel 220 arranged on a wall of a battery compartment 200 formed in the power tool 100. This supporting heel 220 may, e.g., be steel shod and dimensioned to support a significant weight. The batteries disclosed herein may have a weight between 2500 g and 5500 g, and preferably either 3000 g or 5100 g. Thus, robust mechanical support may be required in order to support the battery safely and securely in the mating position.

The batteries discussed herein may furthermore comprise at least one recess 380a, 380b configured to receive a respective locking member of a battery lock mechanism. The recess comprises a surface arranged with an arcuate form to match that of a leading edge portion of the locking member. With reference to FIG. 2, as the battery is received in the battery compartment 200, the locking member or members 250a, 250b are configured to yield as the battery enters the compartment. The locking members 250a, 250b then swing into the recess 380a, 380b formed in the central housing 310 where they prevent the battery from being retracted from the battery compartment. Notably, the arcuate form of the leading edge portion allows the locking mechanism to be rotated out of the locking position with less resistance even if there is some friction between the leading edge portion and the surface arranged to engage the leading edge portion.

The locking member may be arranged spring biased towards the locking position, and operable by means of a lever or push-button mechanism 260, shown in FIG. 2.

The batteries discussed herein are preferably cooled during operation and also during charging. To facilitate cooling, the central housing comprises grated apertures 830a, 830b indicated in FIG. 8. These grated apertures provide a passage for a flow of cooling air to traverse the battery interior through the inner volume of the central housing, thereby transporting heat away from the battery.

According to some aspects, at least one of the elongated slots 350 defines a passage into an internal volume of the central housing 310 for passing a flow of cooling air from the internal volume and out into an ambient environment. Thus, a portion of the flow of cooling air passing between the grated apertures is able to exit via the elongated slots. The flow of cooling air exiting via the slots must be overcome by any dirt or slurry entering the area comprising the electrical connectors. Thus, this area is kept clean of dust and slurry during operation of the power tool, which is most advantageous.

The electrical connectors 810 are optionally surface mounted onto a carrier structure 820 arranged in the central housing 310 as shown in FIG. 8. The carrier structure may further comprise a control unit for controlling an operation of the battery. Thus, a cost efficient design is provided which can be manufactured in fewer steps compared to if the electrical connectors had to be separately wired to the control unit. The carrier structure may, e.g., be a printed circuit board (PCB) comprising the electrical connectors, the control unit, and also any power circuitry required to interconnect and to charge the battery cells of the battery.

FIG. 9 illustrates an example battery cell pack 900 which can be housed in the central housing and held in position by the gable portions. The battery cell pack comprises a plurality of rechargeable battery cells 910. These battery cells 910 may be elongated units extending in a direction transversal to the insertion direction D. For example, a larger battery may comprise 52 cells and a smaller battery may comprise 26 cells, with 4Ah per cell.

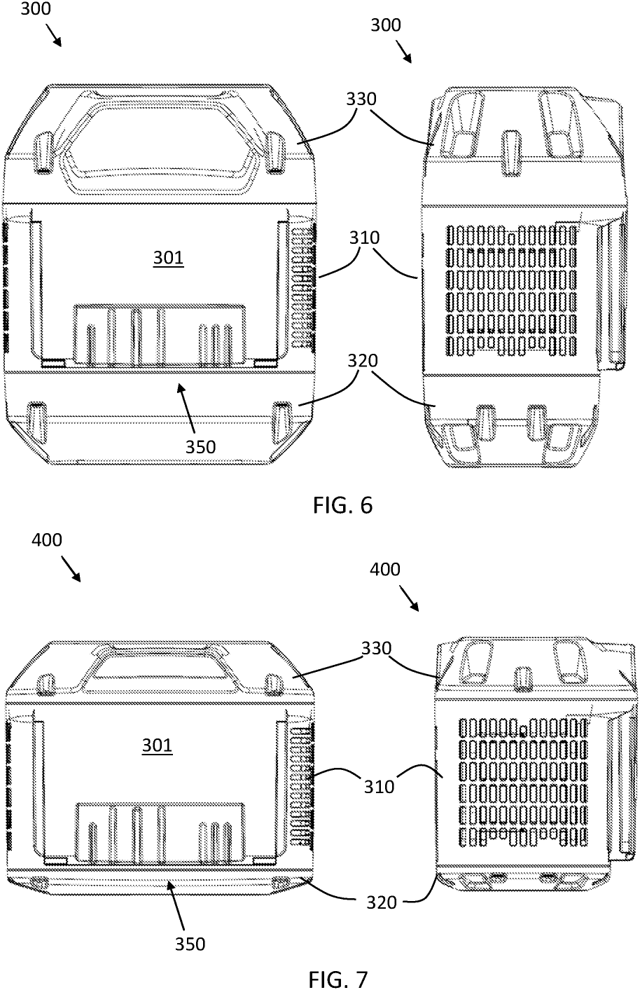

FIGS. 6 and 7 illustrate an example of a modular battery system 300, 400 comprising a plurality of battery types, where each battery type is configured for insertion in an insertion direction D1 into mating position with attachment means of a power tool 100. FIG. 6 shows front and side views of a first battery type 300 in the modular battery system, while FIG. 7 shows front and side views of a second battery type 400 in the modular battery system, where the first type is associated with a larger energy storage capacity compared to the second type, and also a larger weight. Thus, the different types of batteries in the modular battery system have different energy storage capacities, different weights and/or different form factors. Each battery type comprises a central housing 310 defining a central volume, one or more guiding members 340a, 340b arranged on the central housing 310 to guide the battery into the mating position along the insertion direction D1, and also one or more electrical connectors 810 arranged in respective elongated slots 350 formed in the central housing 310, wherein the slots extend in the insertion direction D2. Each battery type further comprises a first gable portion 320, and a second gable portion 330 arranged opposite to the first gable portion, wherein the gable portions 320, 330 extend transversally to a side 301 of the tubular central housing 310, and where each gable portion defines a respective first and second gable volume.

Advantageously, the central housing is the same for each battery type in the plurality of battery types. Only the first and/or second gable volumes differs between the first battery type and the second battery type in the plurality of battery types. This means that the same charger can be used for all battery types, since the interfaces to the battery charger is located only on the central housing which is the same for all battery types. Furthermore, the mechanical attachment means on different power tools can be used for all the battery types, since the guiding members are also arranged on the central housing.

According to aspects, a battery 300 of the first type weighs between 4500-5500 g and preferably about 5100 g, and a battery 400 of the second type weighs between 2500-3500 g and preferably about 3000 g.

1. A battery for a power tool, the battery comprising:
a central housing with a side terminated by a first gable portion, and by a second gable portion opposite to the first gable portion, wherein the first and second gable portions face in an insertion direction of the battery,
one or more guiding members arranged on the central housing to guide the battery along the insertion direction into mating position with attachment means of the power tool,
one or more electrical connectors arranged in respective elongated slots formed in the central housing, wherein the slots extend in the insertion direction,
wherein the one or more guiding members and the elongated slots extend in a plane tangential to the side of the central housing, wherein the battery further comprises a handle arranged on the second gable portion, wherein the handle is offset from a center of the second gable portion towards the plane.

2. The battery according to claim 1, wherein the handle intersects the plane in alignment with the elongated slots and with the one or more guiding members.

3. The battery according to claim 1, wherein the one or more guiding members comprise a first guiding member and a second guiding member extending in the plane, wherein the one or more elongated slots are arranged in-between the first and second guiding members on the side of the central housing.

4. The battery according to claim 1, wherein the first gable portion, and/or the second gable portion is formed with a beveled edge.

5. The battery according to claim 1, wherein the one or more electrical connectors are surface mounted onto a carrier structure arranged in the central housing, wherein the carrier structure further comprises a control unit for controlling an operation of the battery.

6. The battery according to claim 5, wherein the first and/or second gable portion comprises a manual control input interface arranged communicatively coupled to the control unit.

7. The battery according to claim 5, wherein the first and/or second gable portion comprises an information output interface arranged communicatively coupled to the control unit.

8. The battery according to claim 1, wherein the first gable portion and/or the second gable portion are attached to the central housing by one or more releasable fastening members.

9. The battery according to claim 1, wherein the elongated slots and the one or more guiding members are formed in a cuboid shaped protrusion extending from the central housing along a normal vector to the plane, wherein a surface of the cuboid shaped protrusion is parallel to the plane.

10. The battery according to claim 9, wherein a leading edge of the cuboid shaped protrusion forms an abutment arranged to support the battery relative to the power tool when in the mating position.

11. The battery according to claim 1, wherein the handle is formed as a recess in the second gable portion.

12. The battery according to claim 1, wherein at least one of the elongated slots defines a passage into an internal volume of the central housing for passing a flow of cooling air from the internal volume and out into an ambient environment.

13. The battery according to claim 1, wherein the one or more guiding members are arranged to mate with corresponding dove-tail grooves formed in the power tool.

14. The battery according to claim 1, comprising a groove extending in the insertion direction, arranged on a side of the central housing opposite to the elongated slots and the one or more guiding members to mate with a supporting heel arranged on a wall of a battery compartment formed in the power tool.

15. The battery according to claim 1, comprising at least one recess configured to receive a respective locking member of a battery lock mechanism, wherein the recess comprises a surface arranged with an arcuate form to match that of a leading edge portion of the locking member.

16. The battery according to claim 1, having a weight between 2500 g and 5500 g.

17. The battery according to claim 1, comprising a plurality of rechargeable battery cells arranged in a battery cell pack .

18. A modular battery system comprising a plurality of battery types, wherein each battery type is configured for insertion in an insertion direction into mating position with attachment means of a power tool, each battery type comprising
a central housing defining a central volume,
one or more guiding members arranged on the central housing to guide the battery into the mating position along the insertion direction,
one or more electrical connectors arranged in respective elongated slots formed in the central housing, wherein the elongated slots extend in the insertion direction,
each battery type further comprising a first gable portion, and a second gable portion arranged opposite to the first gable portion, wherein the first and second gable portions face in the insertion direction, and wherein each of the first and second gable portions defines a respective first and second gable volume,
wherein the central housing is the same for each battery type in the plurality of battery types, and wherein the first and second gable volumes differ between a first battery type and a second battery type in the plurality of battery types.

19. The modular battery system according to claim 18, wherein a battery of the first battery type weighs between 4500-5500 g, and wherein a battery of the second battery type weighs between 2500-3500 g .
